(19) United States
(12) Patent Application Publication
(10) Pub. No.: US 2013/0301772 A1
(43) Pub. Date: Nov. 14, 2013

(54) Risk Monitoring Device and Risk Monitoring Method for Use with a Nuclear Power Facility

(71) Applicants: Mikhail Evgenievich Fedosovsky, St. Petersburg (RU); Vadim Igorevich Dunaev, St. Petersburg (RU); Aleksandr Evgenievich Sherstobitov, St. Petersburg (RU); Sergey Andreevich Aleksanin, St. Petersburg (RU); Aleksandr Aleksandrovich Syrov, St. Petersburg (RU); Vasiliy Ivanovich Gumenyuk, St. Petersburg (RU)

(72) Inventors: Mikhail Evgenievich Fedosovsky, St. Petersburg (RU); Vadim Igorevich Dunaev, St. Petersburg (RU); Aleksandr Evgenievich Sherstobitov, St. Petersburg (RU); Sergey Andreevich Aleksanin, St. Petersburg (RU); Aleksandr Aleksandrovich Syrov, St. Petersburg (RU); Vasiliy Ivanovich Gumenyuk, St. Petersburg (RU)

(21) Appl. No.: 13/852,608

(22) Filed: Mar. 28, 2013

Related U.S. Application Data
(63) Continuation-in-part of application No. PCT/RU2011/000653, filed on Aug. 26, 2011.

(30) Foreign Application Priority Data
Sep. 28, 2010 (RU) 2010139828

(51) Int. Cl. G21D 3/00

(52) U.S. Cl. CPC G21D 3/001
USPC 376/216

(57) ABSTRACT

The object of the present invention is to provide a risk monitoring device and a risk monitoring method for use with a nuclear power facility, providing continuous determination of risk associated with the nuclear power facility, based on one-type security model, which can be implemented using simple software and hardware means. The risk monitoring device according to the present invention comprises a memory device for storing at least one minimal fault cutset array (MFC) and probability values for each event in each MFC, and a data input device to input in the risk monitoring device data about status changes of the nuclear power facility facility, wherein the risk monitoring device further comprises a formation unit for forming at least one MFC matrix; a memory device for storing said at least one MFC matrix; a formation unit for forming at least one parameter matrix; a memory device for storing said at least one parameter matrix; a modification unit for modifying elements of said at least one parameter matrix; and a risk evaluation unit.

This application is a continuation-in-part of International Application PCT/RU2011/000653 filed Aug. 26, 2011, published on Apr. 5, 2012 under publication number WO 2012/044197 A1 which claims priority benefits to Russian Patent Application 2010139828 filed Sep. 28, 2010, the entire disclosures of which are incorporated herein by reference.

### FIELD OF THE INVENTION

The present invention relates to a risk monitoring device and a risk monitoring method for use with a nuclear power facility. In particular, the present device and method can be used for risk monitoring of nuclear fuel transport and processing equipment.

### BACKGROUND ART

Operation of a nuclear power facility requires meeting safety requirements which may be defined by a maximum allowable risk evaluation value, said risk evaluation pertaining to undesired events related to the facility. During the facility operation, faults in components thereof or other status changes thereof affecting the risk evaluation value may occur. Therefore, there is a need in continuous determination of risk evaluation (called risk monitoring) in accordance with status changes in the nuclear power device.

Various risk monitoring devices are known. According to one operational principle of such devices, risk monitoring is performed by receiving and subsequently continuously changing a security model of the facility, e.g. a fault tree. In this case, risk evaluation can be determined in case of any changes in the facility status; however, the necessary changes of a security model provide substantial difficulties in implementation and may require special personnel training.

According to another operational principle, risk monitoring is performed by pre-receiving several security models corresponding to different facility status change variations with a risk evaluation determination for each variation. During the monitoring process, the risk evaluation is determined based on conformity of the current facility status to one of the contemplated variations. The disadvantage of devices with said operational principle lies in the possibility of accounting for only a limited number of facility status change variations, insufficient for carrying out effective risk monitoring in implementation.

The closest analogue of the present invention is disclosed in U.S. Pat. No. 4,632,802. U.S. Pat. No. 4,632,802 discloses an apparatus for monitoring the degree of risk associated with a monitored facility, in particular with a nuclear power plant. The apparatus provides continuous determination of risk evaluation based on one security model determined by a minimal fault cutset associated with the facility in accordance with status changes in the facility's components.

The device disclosed in the aforementioned publication comprises a memory device for storing one array of minimal fault cutsets (MFC) and probabilities of each event in each MFC; a data input device for inputting data about the status of the facility's components and changes in component fault probability values; means for determining risk evaluation; and means for displaying risk evaluation.

Said device allows to perform risk monitoring based on one security model by modifying the values of said probabilities in accordance with data about the status of the components. Therefore, according to operational principle of said device, it is not required to change the security model or to form several security models.

It must be noted, however, that according to operational principle of the device disclosed in U.S. Pat. No. 4,632,802, the number of events in various MFC can vary, thus presenting difficulties in performing calculations to determine risk evaluation and may require the use of relatively complex software and hardware means. Furthermore, said device allows for risk evaluation based solely on one MFC array associated with one particular undesired event. In practice, however, there is a need for determining risk evaluation based on several undesired events associated with the facility, with an MFC array corresponding to each of said events.

Therefore, there is a need for a risk monitoring device and a risk monitoring method for use with a nuclear power facility, providing effective risk monitoring by continuously determining risk evaluation based on uniform calculations, and using simple software and hardware means, and providing for risk evaluation determination based on one or several MFC arrays, each of said arrays determines an undesired event associated with the facility, so that the nuclear power facility can be timely modified based on the determined risk values to reach the required safety parameters of the nuclear power facility and avoid situations associated with potential damage.

### DISCLOSURE OF THE INVENTION

The object of the present invention is to provide a risk monitoring device and a risk monitoring method for use with a nuclear power facility, providing continuous risk evaluation determination, said risk being associated with the facility, by means of uniform calculations based on one security model, adapted to be implemented using simple software and hardware means.

Another object of the present invention is to provide a risk monitoring device and a risk monitoring method, providing for risk evaluation determination based on several arrays of minimal fault cutsets, each of said cutsets corresponding to an undesired event associated with the facility.

The object is achieved by a risk monitoring device for use with a nuclear power facility comprising

a first memory device for storing at least one MFC array, each of said arrays determining an undesired event associated with the facility, and probability values for each event in each MFC;

a data input device for inputting into the risk monitoring device data about status changes of the facility,

wherein the risk monitoring device further comprises

a first formation unit for forming at least one MFC matrix, said unit adapted to form a rectangular MFC matrix based on each MFC array in such manner that events associated with one MFC form one line of the matrix, wherein a horizontal dimension of the matrix is defined by length of the longest MFC, and lines formed by the MFC and having a shorter length than the horizontal dimension of the MFC matrix are complemented with simulated events with probability of 1;

a second memory device for storing said at least one MFC matrix;

a second formation unit for forming at least one parameter matrix, said unit adapted to form elements of the parameter matrix by substituting corresponding events in each MFC matrix with probability values for each event in each MFC, said values being stored in the corresponding memory device;

a third memory device for storing said at least one parameter matrix;

a modification unit for modifying said at least one parameter matrix, said unit adapted to retrieve data from said memory device for storing the MFC matrix and from the data input device, said unit further adapted to modify values of the elements of said corresponding parameter matrix based on said data;

a risk evaluation unit adapted to evaluate risk associated with said facility based on values of the elements of said at least one parameter matrix.

Therefore, the object is achieved by forming at least one rectangular MFC matrix based on each MFC array corresponding to an undesired event, and by forming at least one rectangular parameter matrix associated with said MFC matrix.

The present device can also further comprise a data display unit adapted to display the risk evaluation value.

In one embodiment of the invention, the risk evaluation unit determines risk evaluations as probabilities of undesired events using the following expression:

$${P}_{n} = 1 - {\prod }_{i = 1}^{{L}_{n}} ( 1 - {\prod }_{j = 1}^{{K}_{n}} {P}_{n , i , j} ) , \qquad ( 1 )$$

where Lₙ, Kₙ are quantities of lines and columns in each of the at least one parameter matrix associated with the undesired event n, respectively, and

P_{n,i,j} is the probability value for address (i,j) in the parametric matrix corresponding to the undesired event n;

n is the number of the undesired event.

In another embodiment, the present device further comprises a memory device for storing damage values associated with each undesired event, and said risk evaluation unit determines risk evaluation using the following expression:

$$R = {\sum }_{n = 1}^{m} [ 1 - {\prod }_{i = 1}^{{L}_{n}} ( 1 - {\prod }_{j = 1}^{{K}_{n}} {P}_{n , i , j} ) ] \cdot {ω}_{n} , \qquad ( 2 )$$

wherein Lₙ, Kₙ are quantities of lines and columns in each of the at least one parameter matrix associated with the undesired event n, respectively,

n is the number of the undesired event;

P_{n,i,j} is the probability value for address (i,j) in the parametric matrix corresponding to the undesired event n;

ωₙ is damage associated with the undesired event n;

m is a total quantity of undesired events.

The object is also achieved by a method for determining risk values.

According to the present invention, the risk evaluation determination method includes steps implemented using a risk monitoring device according to an embodiment of the present invention, comprising a first memory device for storing at least one MFC array, each of said arrays determining an undesired event associated with the facility, and probability values for each event in each MFC; and a data input device for inputting into the risk monitoring device data about status changes of the facility,

wherein the method comprises the steps of,

forming at least one rectangular MFC matrix in a first formation unit, based on each of the MFC arrays, each array corresponding to an undesired event associated with the facility, wherein events corresponding to one MFC form one line of the matrix, wherein a horizontal dimension of the MFC matrix is defined by length of the longest MFC, and lines formed by the MFC and having a shorter length than the horizontal dimensions of the MFC matrix are complemented with simulated events with probability of 1;

forming elements of at least one parameter matrix in a second formation unit, by substituting corresponding events in each MFC matrix with probability values for each event in each MFC;

determining risk values associated with the nuclear power facility in a risk evaluation unit based on values of the elements of said at least one parameter matrix, and

modifying the nuclear power facility based on the determined risk values to reach the required safety parameters of the nuclear power facility and avoid situations associated with potential damage.

Said object is also achieved by a risk monitoring method for use with a nuclear power facility. According to the present invention, the risk monitoring method includes steps implemented using a risk monitoring device according to an embodiment of the present invention, comprising a first memory device for storing at least one MFC array, each of said arrays determining an undesired event associated with the nuclear power facility, and probability values for each event in each MFC; and a data input device for inputting into the risk monitoring device data about status changes of the facility,

wherein the method comprises the steps of:

forming at least one rectangular MFC matrix in a first formation unit based on each of the MFC arrays, each array corresponding to an undesired event associated with the facility, wherein events corresponding to one MFC form one line of the matrix, wherein a horizontal dimensions of the MFC matrix is defined by length of the longest MFC, and lines formed by the MFC and having a shorter length than the horizontal dimensions of the MFC matrix are complemented with simulated events with probability of 1;

forming elements of at least one parameter matrix in a second formation unit by substituting corresponding events in each MFC matrix with probability values for each event in each MFC;

determining a first set of risk values associated with the nuclear power facility in a risk evaluation unit based on values of the elements of said at least one parameter matrix;

receiving by a data input device data about change of the nuclear power facility status;

modifying values of elements of said at least one parameter matrix in accordance with the received data;

determining a second set of risk values associated with the nuclear power facility in a risk evaluation unit based on modified values of the elements of said at least one parameter matrix;

modifying the nuclear power facility based on the second set of determined risk values to reach the required safety parameters of the nuclear power facility and avoid situations associated with potential damage.

In the preferred embodiment of the risk monitoring method, the sequence of steps of receiving data about change of the facility status, modifying values of elements of said at least one parameter matrix in accordance with the received data, and risk evaluation determination, said risk associated with said facility, based on values of the elements of said at least one parameter matrix is repeated multiple times and the nuclear power facility is modified accordingly several times until it reaches the required level of safety parameters that ensures safety operation.

In the aforementioned methods, the probability of undesired events determined using the expression (1) can be used as risk evaluation. In another embodiment of each aforementioned method, a complex factor determined using the expression (2) and taking into account the probabilities of undesired events and predicted damage can be used as risk evaluation.

### BRIEF DESCRIPTION OF THE DRAWINGS

A detailed description of the embodiments of the present invention is disclosed below with reference to accompanying drawings, in which:

FIG. 1 shows a flowchart illustrating the general principle of performing risk monitoring using the risk monitoring device according to the present invention;

FIG. 2 shows a functional flowchart of the risk monitoring device according to one embodiment of the present invention.

### DESCRIPTION OF THE PREFERRED EMBODIMENTS

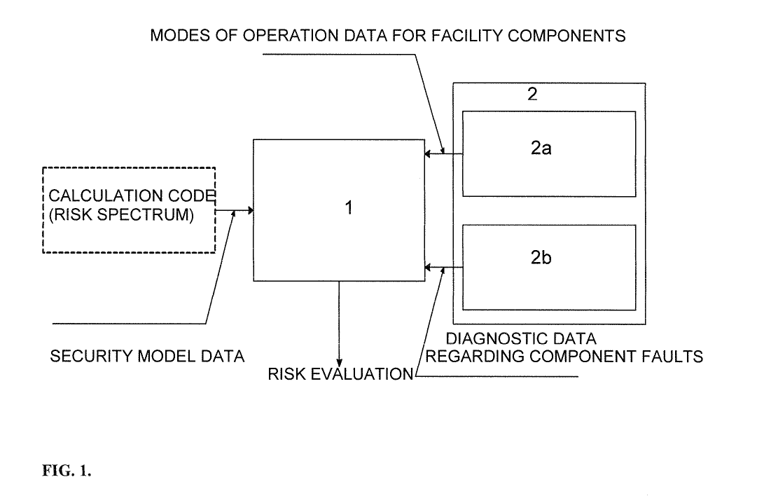

The general principle of performing risk monitoring using the risk monitoring device, said risk defined by at least one undesired event associated with a nuclear power facility, according to the present invention is shown in FIG. 1.

The operation of the present embodiment of a risk monitoring device 1 is based on using one security model comprising data about at least one MFC array, each of said arrays corresponding to an undesired event associated with the facility, and probability values of each event in each MFC. When the present device is used with equipment performing transport and processing of nuclear fuel, the undesired events may comprise, without limitation, events associated with a fuel assembly collapse during a reactor assembly reload or events associated with fuel assembly collision with structural elements of the reactor assembly, etc. Said at least one MFC array and probability values can be obtained during basic facility security model analysis, which can be performed using a calculation code permitted for use in nuclear engineering, for example, the Risk Spectrum calculation code. During risk monitoring, the risk monitoring device receives data about changes in facility status. In particular, as shown in FIG. 1, said data can be received from facility control device 2 and can comprise data about operational modes of the facility's components, wherein the data are received from control section 2a, and diagnostic data about component faults, wherein the data are received from diagnostic section 2b. Based on the received data, the risk monitoring device provides repeatedly risk evaluation determination, said risk associated with the monitored facility.

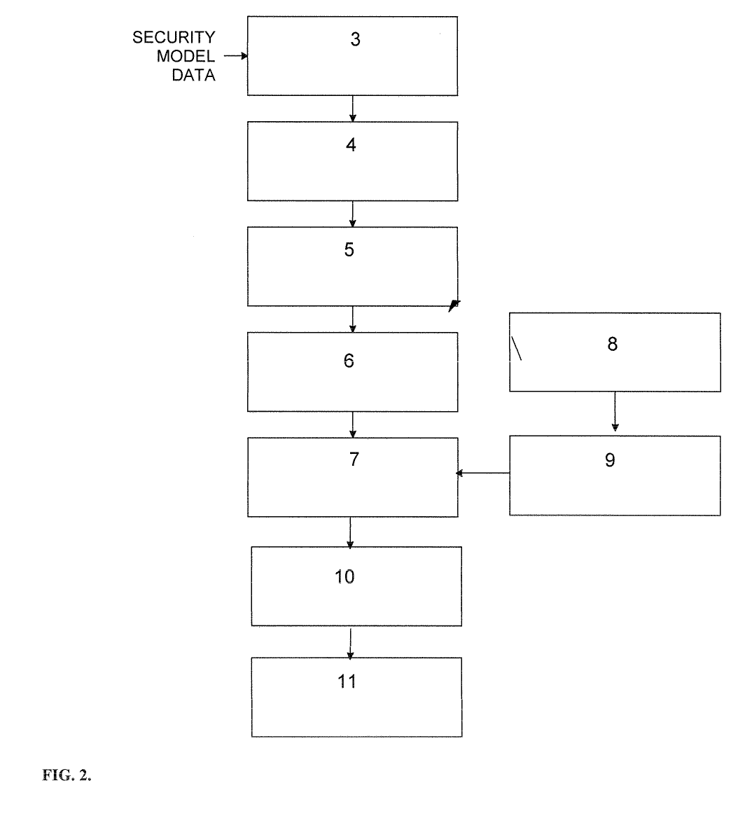

A functional flowchart of the risk monitoring device according to one embodiment of the present invention is shown in FIG. 2. In this embodiment, the exemplary number of undesired events associated with the facility and the number of corresponding MFC arrays are both=2.

The risk monitoring device 1 for use with a nuclear power facility comprises a first memory device 3 for storing two MFC arrays, each array corresponding to an undesired event associated with said facility, and probability values for each event in each MFC, and a data input device 8 adapted to input therein data about status changes of the facility. The present device further comprises a first formation unit 1 for forming at least one MFC matrix, said unit adapted to form rectangular MFC matrices based on each MFC array in such manner that events associated with one MFC form one line of the matrix, wherein a horizontal dimension of the matrix is defined by length of the longest MFC, and lines formed by the MFC and having a shorter length than the horizontal dimension of the MFC matrix are complemented with simulated events with probability of 1; a second memory device 5 for storing MFC matrices; a second formation unit 6 for forming parameter matrices, said unit adapted to form elements of the parameter matrices by substituting corresponding events in each MFC matrix with probability values for each event in each MFC, said values being stored in the corresponding memory device; a third memory device 7 for storing parameter matrices; a modification unit 9 for modifying parameter matrices, said unit adapted to retrieve data from the memory device 5 and the device 8, said unit further adapted to modify values of the elements of each parameter matrix based on said data; a risk evaluation unit 10 adapted to evaluate risk associated with said facility based on values of the elements of parameter matrices; and a data display unit 11 adapted to display the determined risk evaluation.

Undesired event probability values can be used as risk evaluations in the present embodiment with 2 undesired events, said probability values determined using the following expression:

$${P}_{n} = 1 - {\prod }_{i = 1}^{{L}_{n}} ( 1 - {\prod }_{j = 1}^{{K}_{n}} {P}_{n , i , j} ) , \qquad ( 1 )$$

where Lₙ, Kₙ are quantities of lines and columns in each of the at least one parameter matrix associated with the undesired event n, respectively, and

P_{n,i,j} is the probability value for address (i,j) in the parametric matrix corresponding to the undesired event n;

n is the number of the undesired event, which can be 1 or 2.

Device 1 can further comprise a memory device for storing damage values (not shown) associated with each undesired event. In this case, risk value can be used as risk evaluation, said value determined using the following expression:

$$R = {\sum }_{n = 1}^{m} [ 1 - {\prod }_{i = 1}^{{L}_{n}} ( 1 - {\prod }_{j = 1}^{{K}_{n}} {P}_{n , i , j} ) ] \cdot {ω}_{n} , \qquad ( 2 )$$

wherein Lₙ, Kₙ are quantities of lines and columns in each of the at least one parameter matrix associated with the undesired event n, respectively,

n is the number of the undesired event;

P_{n,i,j} is the probability value for address (i,j) in the parametric matrix corresponding to the undesired event n;

ωₙ is damage associated with the undesired event n;

m is a total quantity of undesired events=2.

When using the device 1, data from the first memory device 3 are inputted into unit 4 adapted to form rectangular MFC matrices based on each MFC array in such manner that events associated with one MFC form one line of the matrix, wherein a horizontal dimension of the matrix is defined by length of the longest MFC, and lines formed by the MFC and having a shorter length than the horizontal dimension of the MFC matrix are complemented with simulated events with probability of 1. MFC matrices thus obtained are rectangular, which provides advantages of simple and uniform calculations when determining risk evaluation, as described further. Said MFC matrices formed in unit 4 are stored in the second memory device 5.

Data from the second memory device 5 are inputted into second formation unit 6 adapted to form values of elements of the parameter matrices by substituting corresponding events in each MFC matrix with probability values for each event in each MFC, said values being stored in the first memory device 3. Parameter matrices formed in the corresponding formation unit are stored in the third memory device 7. It should be noted that parameter matrices thus formed (like the MFC matrices) are rectangular.

When performing risk monitoring, data about facility status changes are inputted into facility status change data input device 8, then said data are sent to modifying unit 9 adapted to modify values of elements of parameter matrices stored in the third memory device 7 based on data received from device 8 and data received from the memory device 5. For example, in case of fault in the facility's component, the input device 8 receives data in the form of probability value equal to 1, corresponding to the particular event in MFC matrices. Based on said data, modifying unit 9 determines at least one address in MFC matrices, said address corresponding to said particular event, and modifies probability values at said address in at least one parameter matrix to a value of 1.

Data from modifying unit 9 are sent to risk evaluation unit 10, which determines risk evaluation based on values of elements of the parameter matrix.

Probability values of particular undesired events determined using the expression (1) can be used as risk evaluation. In another embodiment, device 1 can further comprise a memory device for storing damage values (not shown) associated with each undesired event. In this embodiment, a complex factor determined using the expression (2) and taking into account the probabilities of undesired events and predicted damage can be used as risk evaluation. Damage values ωₙ can be determined prior to starting device operation, for example, in numerical or cost values, and can be stored in the corresponding memory device.

It should be noted that the number of elements in each line of the parameter matrices used in risk evaluation determination, e.g. by using the above expressions, is constant due to the rectangular nature of each said matrix, as described above. This allows to achieve simple and uniform calculations performed when determining risk evaluation, and components of the present device, units 9 and 10 in particular, are implemented using simple software and hardware means.

Then, the determined risk evaluation is displayed by unit 11.

In further use of the device 1, values of elements of parameter matrices can be modified multiple times in accordance with data about facility status changes, and the risk evaluation can be determined repeatedly, thus allowing to perform effective monitoring of risk associated with a nuclear power facility.

What is claimed is:

1. A risk monitoring device for use with a nuclear power facility, comprising:
a first memory device for storing at least one minimal fault cutset (MFC) array corresponding to an undesired event associated with said facility, and for storing probability values for each event in each MFC;
a data input device for inputting in the risk monitoring device data about status changes of the facility;
a first formation unit for forming at least one minimal fault cutset (MFC) matrix, wherein the first formation unit is adapted to form a rectangular MFC matrix based on each MFC array in such manner that events associated with one MFC form one line of the matrix, wherein a horizontal dimension of the matrix is defined by length of the longest MFC, and lines formed by the MFC and having a shorter length than the horizontal dimension of the MFC matrix are complemented with simulated events with probability of 1;
a second memory device for storing said at least one MFC matrix;
a second formation unit for forming at least one parameter matrix, wherein the second formation unit is adapted to form elements of the parameter matrix by substituting corresponding events in each MFC matrix with probability values for each event in each MFC, said values being stored in the corresponding memory device;
a third memory device for storing said at least one parameter matrix;
a modification unit for modifying elements of said at least one parameter matrix, wherein the modification unit is adapted to retrieve data from said memory device for storing the MFC matrix and from the data input device, said unit further adapted to modify values of the elements of said parameter matrix based on said data; and
a risk evaluation unit adapted to evaluate risk associated with said nuclear power facility based on values of the elements of said at least one parameter matrix.

2. Device of claim 1, further comprising a data display unit adapted to display the determined risk evaluation.

3. Device of claim 1, wherein the risk evaluation unit determines risk evaluations as probabilities of undesired events using the following expression:
$${P}_{n} = 1 - {\prod }_{i = 1}^{{L}_{n}} ( 1 - {\prod }_{j = 1}^{{K}_{n}} {P}_{n , i , j} ) ,$$
where Lₙ, Kₙ are quantities of lines and columns in each of the at least one parameter matrix associated with the undesired event n, respectively, and
P_{n,i,j} is the probability value for address (i,j) in the parametric matrix corresponding to the undesired event n;
n is the number of the undesired event.

4. Device of claim 3, further comprising a data display unit adapted to display the determined probability of the predetermined undesired event.

5. Device of claim 1, further comprising a memory device for storing damage values associated with each undesired event, and wherein said risk evaluation unit determines risk value using the following expression:
$$R = {\sum }_{n = 1}^{m} [ 1 - {\prod }_{i = 1}^{{L}_{n}} ( 1 - {\prod }_{j = 1}^{{K}_{n}} {P}_{n , i , j} ) ] \cdot {ω}_{n} , ,$$
wherein Lₙ, Kₙ are quantities of lines and columns in each of the at least one parameter matrix associated with the undesired event n, respectively,
n is the number of the undesired event;
P_{n,i,j} is the probability value for address (i,j) in the parametric matrix corresponding to the undesired event n;
ωₙ is damage associated with the undesired event n;
m is a total quantity of undesired events.

6. Device of claim 5, further comprising a data display unit adapted to display the determined risk value.

7. A computer implemented method for determining risk associated with a nuclear power facility using a risk monitoring device comprising a first memory device, a data input device, a first formation unit, a second memory device, a second formation unit, a third memory device, a modification unit, and a risk evaluation unit,
wherein the said method comprises the steps of
storing in the first memory device at least one minimal fault cutset (MFC) array corresponding to an undesired event associated with said facility, and probability values for each event in each MFC,
inputting in the data input device of the risk monitoring device data about status changes of the facility;
forming at least one rectangular MFC matrix in a first formation unit, using each of the minimum fault cutset arrays stored in the first memory device, wherein each array corresponds to an undesired event associated with the facility, in such manner that events corresponding to one MFC form one line of the matrix, the horizontal dimension of the MFC matrix is defined by the length of the longest MFC, and lines formed by the MFC and having a shorter length than the horizontal dimension of the MFC matrix are complemented with simulated events with the probability of 1;
storing the said at least one MFC matrix in the second memory device;
forming elements of at least one parameter matrix in a second formation unit by substituting corresponding events in each of the said at least one rectangular MFC matrix with probability values for each event in each MFC;
storing said at least one parameter matrix in a third memory device;
determining risk values associated with the facility in the said risk evaluation unit based on the values of the elements of said at least one parameter matrix, and
modifying via the risk monitoring device, the nuclear power facility based on the determined risk values to reach the required safety parameters of the nuclear power facility.

8. Method of claim 7, wherein risk evaluations are determined as probabilities of undesired events calculated using the following expression:
$${P}_{n} = 1 - {\prod }_{i = 1}^{{L}_{n}} ( 1 - {\prod }_{j = 1}^{{K}_{n}} {P}_{n , i , j} ) ,$$
where Lₙ, Kₙ are quantities of lines and columns in each of the at least one parameter matrix associated with the undesired event n, respectively, and
P_{n,i,j} is the probability value for address (i,j) in the parametric matrix corresponding to the undesired event n;
n is the number of the undesired event.

9. Method of claim 7, wherein risk evaluation is determined as risk value calculated using the following expression:
$$R = {\sum }_{n = 1}^{m} [ 1 - {\prod }_{i = 1}^{{L}_{n}} ( 1 - {\prod }_{j = 1}^{{K}_{n}} {P}_{n , i , j} ) ] \cdot {ω}_{n} , ,$$
wherein Lₙ, Kₙ are quantities of lines and columns in each of the at least one parameter matrix associated with the undesired event n, respectively,
n is the number of the undesired event;
P_{n,i,j} is the probability value for address (i,j) in the parametric matrix to corresponding to the undesired event n;
ωₙ is damage associated with the undesired event n;
m is a total quantity of undesired events.

10. A method for monitoring risk associated with a nuclear power facility, using a risk monitoring device comprising a first memory device, a data input device, a first formation unit, a second memory device, a second formation unit, a third memory device, a modification unit, and a risk evaluation unit,
wherein the said method comprises the steps of
storing in the first memory device at least one minimal fault cutset (MFC) array corresponding to an undesired event associated with said facility, and probability values for each event in each MFC,
inputting in the data input device of the risk monitoring device data about status changes of the facility;
forming at least one rectangular minimum fault cutset (MFC) matrix in the first formation unit based on each of the minimum fault cutset arrays stored in the first memory device, wherein each of the arrays corresponds to an undesired event associated with the nuclear power facility, in such manner that events corresponding to one MFC form one line of the matrix, wherein a horizontal dimension of the MFC matrix is defined by length of the longest MFC, and lines formed by the MFC and having a shorter length than the horizontal dimension of the MFC matrix are complemented with simulated events with probability of 1;
storing the said at least one MFC matrix in the second memory device;
forming elements of at least one parameter matrix in a second formation unit, wherein values of the elements in the said at least one parameter matrix are formed by substituting corresponding events in each MFC matrix with probability values for each event in each MFC;
storing said at least one parameter matrix in a third memory device; determining risk values associated with the nuclear power facility in the risk evaluation unit based on values of the elements of said at least one parameter matrix stored in the third memory device; receiving by a data input device data about change of the facility status;
modifying values of the elements of said at least one parameter matrix stored in the third memory device, in accordance with the received data;
determining risk values associated with the nuclear power facility in the risk evaluation unit based on modified values of the elements of said at least one parameter matrix;
modifying via the risk monitoring device, the nuclear power facility based on the determined risk values to reach the required safety parameters of the nuclear power facility.

11. Method of claim 10, wherein the sequence of steps of receiving data about change of the facility status, modifying values of elements of said at least one parameter matrix in accordance with the received data, and risk evaluation determination, said risk associated with said facility, based on values of the elements of said at least one parameter matrix is repeated multiple times.

12. Method of claim 10, wherein risk evaluations are determined as probabilities of undesired events calculated using the following expression:
$${P}_{n} = 1 - {\prod }_{i = 1}^{{L}_{n}} ( 1 - {\prod }_{j = 1}^{{K}_{n}} {P}_{n , i , j} ) ,$$
where Lₙ, Kₙ are quantities of lines and columns in each of the at least one parameter matrix associated with the undesired event n, respectively, and
P_{n,i,j} is the probability value for address (i,j) in the parametric matrix corresponding to the undesired event n;
n is the number of the undesired event.

13. Method of claim 10, wherein risk evaluation is determined as risk value calculated using the following expression:
$$R = {\sum }_{n = 1}^{m} [ 1 - {\prod }_{i = 1}^{{L}_{n}} ( 1 - {\prod }_{j = 1}^{{K}_{n}} {P}_{n , i , j} ) ] \cdot {ω}_{n} , ,$$
wherein Lₙ, Kₙ are quantities of lines and columns in each of the at least one parameter matrix associated with the undesired event n, respectively,
n is the number of the undesired event;
P_{n,i,j} is the probability value for address (i,j) in the parametric matrix corresponding to the undesired event n;
∫ₙ is damage associated with the undesired event n;
m is a total quantity of undesired events.
